(19) United States
(12) Patent Application Publication
(10) Pub. No.: US 2010/0271481 A1
(43) Pub. Date: Oct. 28, 2010

(54) Maneuver Assisting Apparatus

(75) Inventor: Hitoshi HONGO, Shijonawate-shi (JP)

Correspondence Address: NOVAK DRUCE + QUIGG LLP, 300 NEW JERSEY AVENUE, NW, FIFTH FLOOR, WASHINGTON, DC, 20001, US

(73) Assignee: SANYO ELECTRIC CO., LTD., Osaka (JP)

(21) Appl. No.: 12/731,174

(22) Filed: Mar. 25, 2010

(30) Foreign Application Priority Data
Apr. 23, 2009 (JP) 2009-105358

(51) Int. Cl. H04N 7/18

(52) U.S. Cl. 348/148; 348/E07.085

(57) ABSTRACT

A maneuver assisting apparatus is arranged on a vehicle that moves on a road surface, and includes a plurality of cameras that capture the road surface from diagonally above. A CPU repeatedly creates a complete-surround birds-eye view image relative to a road surface, based on a plurality of object scene images repeatedly outputted from the plurality of cameras. The created complete-surround bird's-eye view image is reproduced on a monitor screen. The CPU determines whether or not there is a three-dimensional object such as an architectural structure in a side portion of a direction orthogonal to a moving direction of the vehicle, based on the complete-surround bird's-eye view image created as described above. Also, the CPU adjusts a ratio of a partial image equivalent to a side portion noticed for a determining process, to the complete-surround bird's-eye view image reproduced on the monitor screen, based on a determination result.

### CROSS REFERENCE OF RELATED APPLICATION

The disclosure of Japanese Patent Application No. 2009-105358, which was filed on Apr. 23, 2009, is incorporated herein by reference.

### BACKGROUND OF THE INVENTION

1. Field of the Invention

The present invention relates to a maneuver assisting apparatus. More particularly, the present invention relates to a maneuver assisting apparatus which assists maneuvering a moving object by reproducing a bird's-eye view image representing a surrounding area of the moving object.

2. Description of the Related Art

According to this type of apparatus, a shooting image of a surrounding area of a vehicle is acquired from a camera mounted on the vehicle. On a screen of a display device, a first display area and a second display area are arranged. The first display area is assigned to a center of the screen, and the second display area is assigned to a surrounding area of the screen. A shooting image in a first range of the surrounding area of the vehicle is displayed in the first display area, and a shooting image in a second range outside of the first range is displayed in the second display area in a compressed state.

However, manners of displaying the shooting images are fixed both in the first display area and in the second display area. Thus, in the above-described apparatus, there is a limit on a maneuver assisting performance.

### SUMMARY OF THE INVENTION

A maneuver assisting apparatus according to the present invention, comprises: a plurality of cameras which are arranged on a moving object that moves on a reference surface and which capture the reference surface from diagonally above; a creator which repeatedly creates a bird's-eye view image relative to the reference surface based on an object scene image repeatedly outputted from each of the plurality of cameras; a reproducer which reproduces the bird's-eye view image created by the creator; a determiner which determines whether or not there is a three-dimensional object in a side portion of a direction orthogonal to a moving direction of the moving object based on the bird's-eye view image created by the creator; and an adjuster which adjusts a ratio of a partial image equivalent to the side portion noticed by the determiner to the bird's-eye view image reproduced by the reproducer based on a determination result of the determiner.

Preferably, the determiner includes: a detector which repeatedly detects a motion vector amount of the partial image equivalent to the side portion out of the bird's-eye view image; an updater which updates a variable in a manner different depending on a magnitude relationship between the motion vector amount detected by the detector and a threshold value; and a finalizer which finalizes the determination result at a time point which a variable updated by the updater satisfies a predetermined condition.

More preferably, the determiner further includes a threshold value adjustor which adjusts a magnitude of the threshold value with reference to a moving speed of the moving object.

Preferably, the adjuster includes a changer which changes a size of the partial image and a controller which starts the changer when the determination result is positive and stops the changer when the determination result is negative.

In a certain aspect, the changer decreases a size in a direction orthogonal to the moving direction of the moving object.

In other aspect, the reproducer displays a bird's-eye view image belonging to a designated area out of the bird's-eye view image created by the creator on a screen, and the adjustor further includes a definer which defines the designated area in a manner to have a size corresponding to a size of the partial image and an adjustor which adjusts a factor of the birds-eye view image belonging to the designated area so that a difference in size between the designated area and the screen is compensated.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of the present invention;

FIG. 2 is a block diagram showing a configuration of one embodiment of the present invention;

FIG. 3 is an illustrative view showing a viewing field captured by a plurality of cameras attached to a vehicle;

FIG. 4(A) is an illustrative view showing one example of a bird's-eye view image based on output of a front camera;

FIG. 4(B) is an illustrative view showing one example of a bird's-eye view image based on output of a right camera;

FIG. 4(C) is an illustrative view showing one example of a bird's-eye view image based on output of a rear camera;

FIG. 4(D) is an illustrative view showing one example of a bird's-eye view image based on output of a left camera;

FIG. 5 is an illustrative view showing one portion of a creating operation of a complete-surround bird's-eye view image;

FIG. 6 is an illustrative view showing one example of a created complete-surround birds-eye view image;

FIG. 7 is an illustrative view showing one example of a drive assisting image displayed by a display device;

FIG. 8 is an illustrative view showing an angle of a camera attached to a vehicle;

FIG. 9 is an illustrative view showing a relationship among a camera coordinate system, a coordinate system of an imaging surface, and a world coordinate system;

FIG. 10 is an illustrative view showing one portion of a detecting operation of a motion vector;

FIG. 11 is an illustrative view showing one example of a distribution state of a complete-surround bird's-eye view image and a motion vector amount corresponding thereto;

FIG. 12(A) is a timing chart showing one example of appearance/disappearance of an architectural structure;

FIG. 12(B) is a timing chart showing one example of an updating operation of variables L_1 and L_2;

FIG. 12(C) is a timing chart showing one example of an updating operation of flags FLG_1 and FLG_2;

FIG. 13 is an illustrative view showing another portion of the creating operation of a complete-surround bird's-eye view image;

FIG. 14 is a flowchart showing one portion of an operation of a CPU applied to the embodiment in FIG. 2;

FIG. 15 is a flowchart showing another portion of the operation of the CPU applied to the embodiment in FIG. 2;

FIG. 16 is a flowchart showing still another portion of the operation of the CPU applied to the embodiment in FIG. 2;

FIG. 17 is a flowchart showing yet still another portion of the operation of the CPU applied to the embodiment in FIG. 2; and

FIG. 18 is an illustrative view showing one portion of a creating operation of a complete-surround bird's-eye view image in another embodiment.

### DETAILED DESCRIPTION OF THE PREFERRED EMBODIMENTS

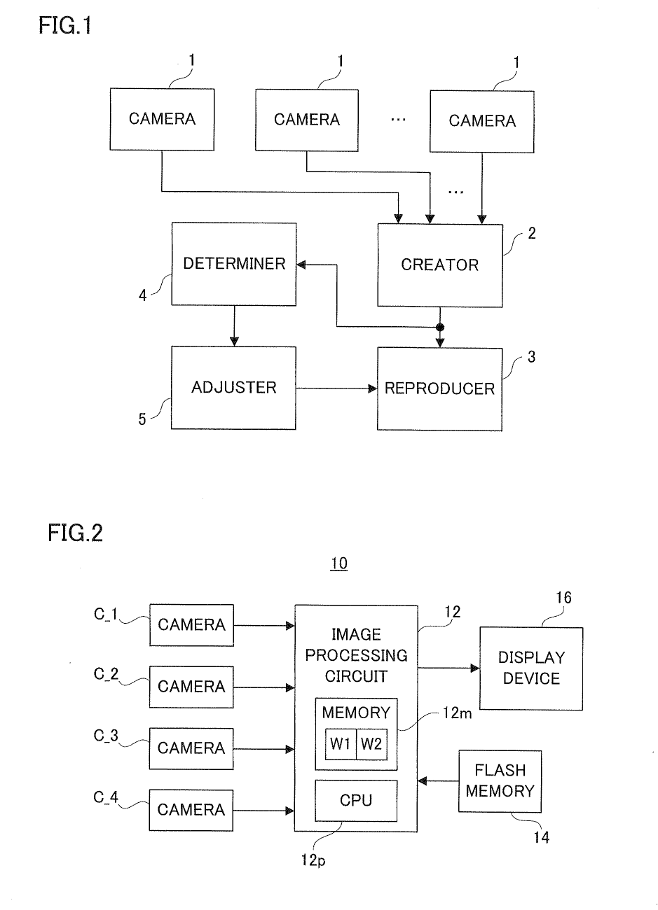

With reference to FIG. 1, a maneuver assisting apparatus of the present invention is basically configured as follows: A plurality of cameras 1, 1, . . . are arranged in a moving object that moves on a reference surface, and capture the reference surface from diagonally above. A creator 2 repeatedly creates a bird's-eye view image arranged relative to the reference surface, based on an object scene image repeatedly outputted from each of the plurality of cameras 1, 1, . . . . The bird's-eye view image created by the creator 2 is reproduced by a reproducer 3. A determiner 4 determines whether or not there is a three-dimensional object in a side portion of a direction orthogonal to a moving direction of the moving object, based on the bird's-eye view image created by the creator 2. An adjuster 5 adjusts a ratio of a partial image equivalent to the side portion noticed by the determiner 4, to the bird's-eye view image reproduced by the reproducer 3, based on a determination result of the determiner 4.

The ratio of the partial image equivalent to the side portion of the direction orthogonal to the moving direction of the moving object is adjusted in a manner to be differed depending on whether or not this partial image is equivalent to the three-dimensional object image. Thus, a reproducibility of the bird's-eye view image is adaptively controlled, and as a result, a maneuver assisting performance is improved.

A maneuver assisting apparatus 10 of this embodiment shown in FIG. 2 includes four cameras C_1 to C_4. The cameras C_1 to C_4 respectively output object scene images P_1 to P_4 in synchronization with a common timing signal at every 1/30 seconds. The outputted object scene images P_1 to P_4 are applied to an image processing circuit 12.

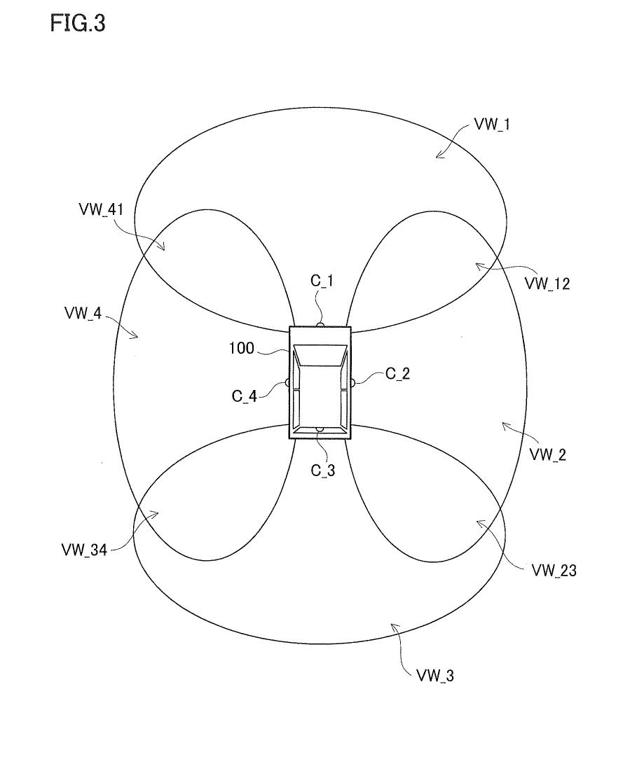

With reference to FIG. 3, the camera C_1 is installed at a front center of a vehicle 100 so that an optical axis of the camera C_1 is oriented to extend in a forward diagonally downward direction of the vehicle 100. The camera C_2 is installed at an upper right portion of the vehicle 100 so that an optical axis of the camera C_2 is oriented to extend in a rightward diagonally downward direction of the vehicle 100. The camera C_3 is installed at a rear center of the vehicle 100 so that an optical axis of the camera C_3 is oriented to extend in a backward diagonally downward direction of the vehicle 100. The camera C_4 is installed at an upper left portion of the vehicle 100 so that an optical axis of the camera C_4 is oriented to extend in a leftward diagonally downward direction of the vehicle 100. An object scene of a surrounding area of the vehicle 100 is captured by such cameras C_1 to C_4 from a direction diagonally crossing a road surface.

The camera C_1 has a viewing field VW_1 capturing a forward portion of the vehicle 100, the camera C_2 has a viewing field VW_2 capturing a right direction of the vehicle 100, the camera C_3 has a viewing field VW_3 capturing a backward portion of the vehicle 100, and the camera C_4 has a viewing field VW_4 capturing a left direction of the vehicle 100. Furthermore, the viewing fields VW_1 and VW_2 have a common viewing field VW_12, the viewing fields VW_2 and VW_3 have a common viewing field VW_23, the viewing fields VW_3 and VW_4 have a common viewing field VW_34, and the viewing fields VW_4 and VW_1 have a common viewing field VW_41.

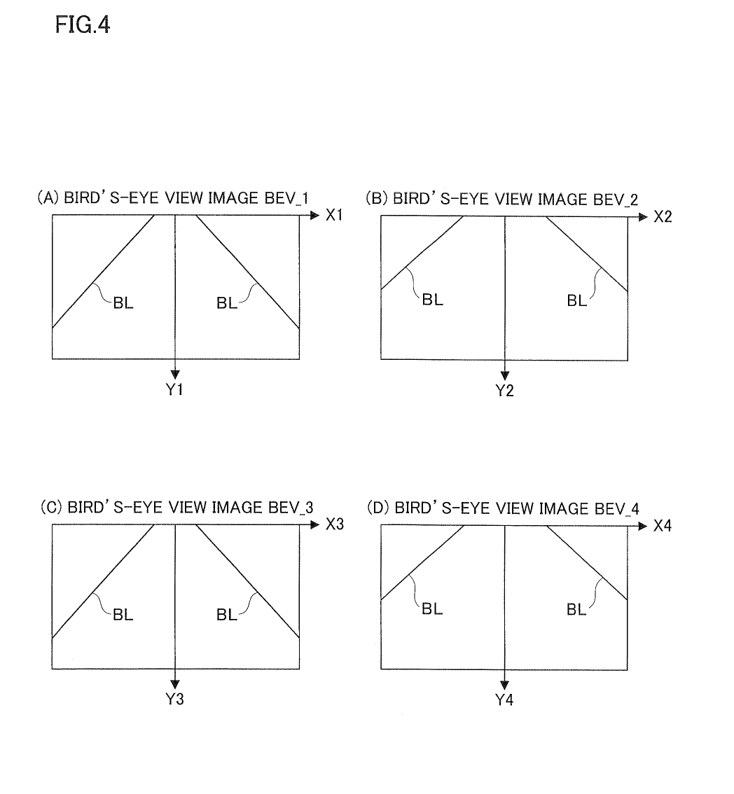

Returning to FIG. 2, a CPU 12p arranged in the image processing circuit 12 produces a birds-eye view image BEV_1 shown in FIG. 4(A) based on the object scene image P_1 outputted from the camera C_1, and produces a birds-eye view image BEV_2 shown in FIG. 4(B) based on the object scene image P_2 outputted from the camera C_2. The CPU 12p further produces a bird's-eye view image BEV_3 shown in FIG. 4(C) based on the object scene image P_3 outputted from the camera C_3, and a bird's-eye view image BEV_4 shown in FIG. 4(D) based on the object scene image P_4 outputted from the camera C_4.

The bird's-eye view image BEV_1 is equivalent to an image captured by a virtual camera looking perpendicularly down on the viewing field VW_1, and the bird's-eye view image BEV_2 is equivalent to an image captured by a virtual camera looking perpendicularly down on the viewing field VW_2. Moreover, the bird's-eye view image BEV_3 is equivalent to an image captured by a virtual camera looking perpendicularly down on the viewing field VW_3, and the bird's-eye view image BEV_4 is equivalent to an image captured by a virtual camera looking perpendicularly down on the viewing field VW_4.

According to FIG. 4(A) to FIG. 4(D), the bird's-eye view image BEV_1 has a bird's-eye-view coordinate system X1-Y1, the bird's-eye view image BEV_2 has a bird's-eye-view coordinate system X2-Y2, the bird's-eye view image BEV_3 has a bird's-eye-view coordinate system X3-Y3, and the bird's-eye view image BEV_4 has a bird's-eye-view coordinate system X4-Y4. Such bird's-eye view images BEV_1 to BEV_4 are held in a work area W1 of a memory 12m.

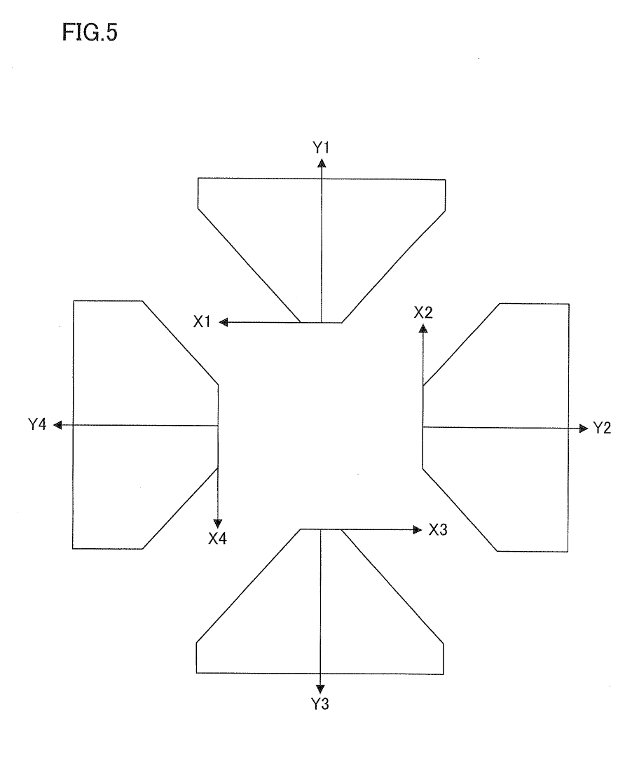

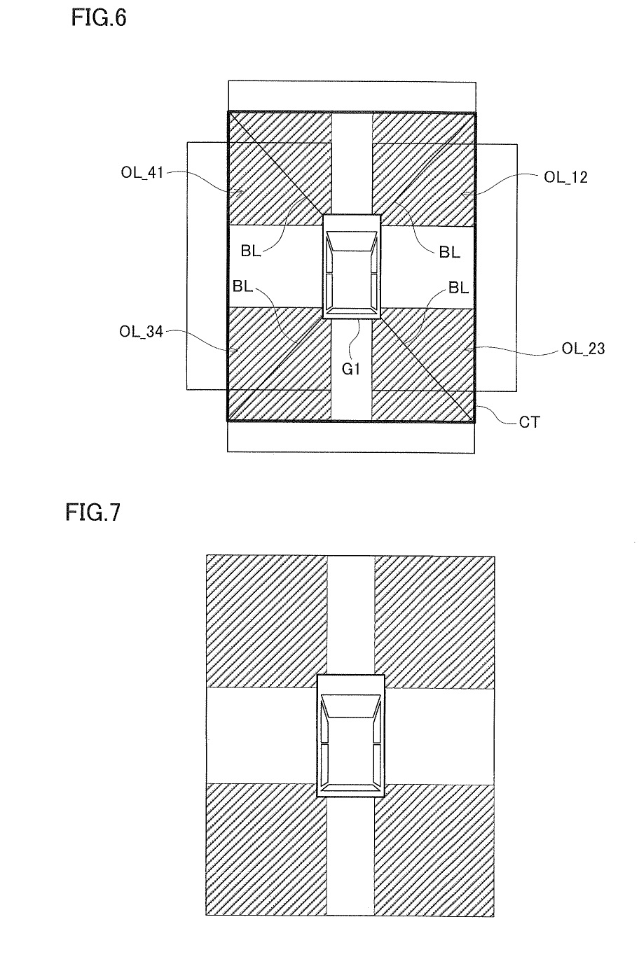

Subsequently, the CPU 12p deletes a part of the image outside of a borderline BL from each of the bird's-eye view images BEV_1 to BEV_4, and combines together the other part (that is left after the deletion) of the bird's-eye view images BEV_1 to BEV_4 (see FIG. 5) by a rotating/moving process. Upon completion of the combining process, the CPU 12p pastes a vehicle image G1 resembling an upper portion of the vehicle 100, to a center of the combined image. As a result, a complete-surround bird's-eye view image shown in FIG. 6 is obtained within a work area W2 of the memory 12m.

In FIG. 6, an overlapped area OL_12 indicated by a hatched line is equivalent to the common viewing field VW_12, and an overlapped area OL_23 indicated by a hatched line is equivalent to the common viewing field VW_23. Moreover, an overlapped area OL_34 indicated by a hatched line is equivalent to the common viewing field VW_34, and an overlapped area OL_41 indicated by a hatched line is equivalent to the common viewing field VW_41.

The CPU 12p defines a cut-out area CT on the complete-surround birds-eye view image secured in the work area W2, and calculates a zoom factor by which a difference between a screen size of the display device 16 set to a cockpit and a size of the cut-out area is compensated. Thereafter, the CPU 12p creates a display command in which the defined cut-out area CT and the calculated zoom factor are written, and issues the created display command to the display device 16.

The display device 16 refers to a writing of the display command so as to read out one portion of the complete-surround bird's-eye view image belonging to the cut-out area CT, from the work area W2, and performs a zoom process on the read-out complete-surround birds-eye view image. As a result, a drive assisting image shown in FIG. 7 is displayed on the monitor screen.

Subsequently, a manner of creating the bird's-eye view images BEV_1 to BEV_4 is described. It is noted that the bird's-eye view images BEV_1 to BEV_4 are all created in the same manner, and thus, a manner of creating the birds-eye view image BEV3, which represents the bird's-eye view images BEV_1 to BEV_4, is described.

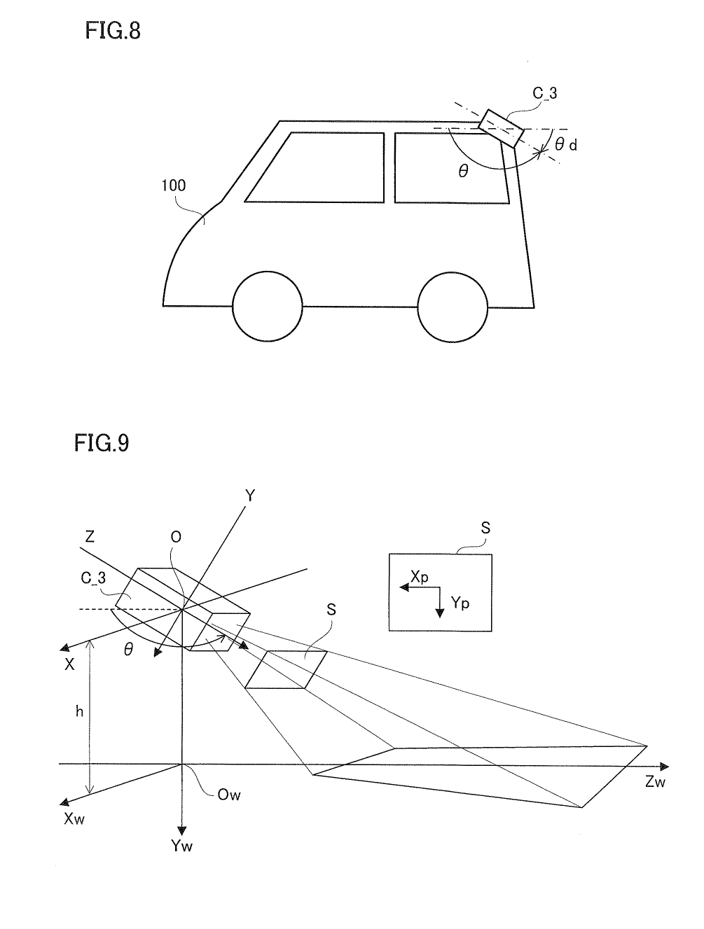

With reference to FIG. 8, the camera C_3 is installed at a rear portion of the vehicle 100 in a manner to be oriented in a backward diagonally downward direction. If an angle of depression of the camera C_3 is “θd”, then an angle θ shown in FIG. 8 is equivalent to “180 degrees-θd”. Furthermore, the angle θ is defined in a range of 90 degrees <θ<180 degrees.

FIG. 9 shows a relationship among a camera coordinate system X-Y-Z, a coordinate system Xp-Yp of an imaging surface S of the camera C_3, and a world coordinate system Xw-Yw-Zw. The camera coordinate system X-Y-Z is a three-dimensional coordinate system where an X axis, Y axis, and Z axis are coordinate axes. The coordinate system Xp-Yp is a two-dimensional coordinate system where an Xp axis and Yp axis are coordinate axes. The world coordinate system Xw-Yw-Zw is a three-dimensional coordinate system where an Xw axis, Yw axis, and Zw axis are coordinate axes.

In the camera coordinate system X-Y-Z, an optical center of the camera C3 is used as an origin O, and in this state, the Z axis is defined in an optical axis direction, the X axis is defined in a direction orthogonal to the Z axis and parallel to the road surface, and the Y axis is defined in a direction orthogonal to the Z axis and X axis. In the coordinate system Xp-Yp of the imaging surface S, a center of the imaging surface S is used as the origin, and in this state, the Xp axis is defined in a lateral direction of the imaging surface S and the Yp axis is defined in a vertical direction of the imaging surface S.

In the world coordinate system Xw-Yw-Zw, an intersecting point between: a perpendicular straight line passing through the origin O of the camera coordinate system X-Y-Z; and the road surface is used as an origin Ow, and in this state, a Yw axis is defined in a direction vertical to the road surface, an Xw axis is defined in a direction parallel to the X axis of the camera coordinate system X-Y-Z, and a Zw axis is defined in a direction orthogonal to the Xw axis and Yw axis. Also, a distance from the Xw axis to the X axis is “h”, and an obtuse angle formed by the Zw axis and the Z axis is equivalent to the above described angle θ.

When coordinates in the camera coordinate system X-Y-Z are written as (x, y, z), “x”, “y”, and “z” indicate an X-axis component, a Y-axis component, and a Z-axis component in the camera coordinate system X-Y-Z, respectively. When coordinates in the coordinate system Xp-Yp of the imaging surface S are written as (xp, yp), “xp” and “yp” indicate an Xp-axis component and a Yp-axis component in the coordinate system Xp-Yp of the imaging surface S, respectively. When coordinates in the world coordinate system Xw-Yw-Zw are written as (xw, yw, zw), “xw”, “yw”, and “zw” indicate an Xw-axis component, a Yw-axis component, and a Zw-axis component in the world coordinate system Xw-Yw-Zw, respectively.

A transformation equation between the coordinates (x, y, z) of the camera coordinate system X-Y-Z and the coordinates (xw, yw, zw) of the world coordinate system Xw-Yw-Zw is represented by Equation 1 below:

$$[ \begin{matrix}x \\ y \\ z\end{matrix} ] = [ \begin{matrix}1 & 0 & 0 \\ 0 & cos θ & - sin θ \\ 0 & sin θ & cos θ\end{matrix} ] \{ [ \begin{matrix}xw \\ yw \\ zw\end{matrix} ] + [ \begin{matrix}0 \\ h \\ 0\end{matrix} ] \} \qquad [ Equation 1 ]$$

Herein, if a focal length of the camera C_3 is “f”, then a transformation equation between the coordinates (xp, yp) of the coordinate system Xp-Yp of the imaging surface S and the coordinates (x, y, z) of the camera coordinate system X-Y-Z is represented by Equation 2 below:

$$[ \begin{matrix}xp \\ yp\end{matrix} ] = [ \begin{matrix}f \frac{x}{z} \\ f \frac{y}{z}\end{matrix} ] \qquad [ Equation 2 ]$$

Furthermore, based on Equation 1 and Equation 2, Equation 3 is obtained. Equation 3 shows a transformation equation between the coordinates (xp, yp) of the coordinate system Xp-Yp of the imaging surface S and the coordinates (xw, zw) of the two-dimensional road-surface coordinate system Xw-Zw.

$$[ \begin{matrix}xp \\ yp\end{matrix} ] = [ \begin{matrix}\frac{fxw}{h sin θ + zw cos θ} \\ \frac{( h cos θ - zw sin θ ) f}{h sin θ + zw cos θ}\end{matrix} ] \qquad [ Equation 3 ]$$

Furthermore, a bird's-eye-view coordinate system X3-Y3, which is a coordinate system of the bird's-eye view image BEV_3 shown in FIG. 4(C), is defined. The bird's-eye-view coordinate system X3-Y3 is a two-dimensional coordinate system where an X3 axis and Y3 axis are used as coordinate axes. When coordinates in the bird's-eye-view coordinate system X3-Y3 are written as (x3, y3), a position of each pixel forming the bird's-eye view image BEV_3 is represented by coordinates (x3, y3). Each of “x3” and “y3” indicates an X3-axis component and a Y3-axis component in the bird's-eye-view coordinate system X3-Y3.

A projection from the two-dimensional coordinate system Xw-Zw that represents the road surface onto the bird's-eye-view coordinate system X3-Y3 is equivalent to a so-called parallel projection. When a height of a virtual camera, i.e., a virtual view point, is assumed as “H”, a transformation equation between the coordinates (xw, zw) of the two-dimensional coordinate system Xw-Zw and the coordinates (x3, y3) of the bird's-eye-view coordinate system X3-Y3 is represented by Equation 4 below. The height H of the virtual camera is previously determined.

$$[ \begin{matrix}x 3 \\ y 3\end{matrix} ] = \frac{f}{H} [ \begin{matrix}xw \\ zw\end{matrix} ] \qquad [ Equation 4 ]$$

Furthermore, based on Equation 4, Equation 5 is obtained, and based on Equation 5 and Equation 3, Equation 6 is obtained. Moreover, based on Equation 6, Equation 7 is obtained. Equation 7 is equivalent to a transformation equation for transforming the coordinates (xp, yp) of the coordinate system Xp-Yp of the imaging surface S into the coordinates (x3, y3) of the bird's-eye-view coordinate system X3-Y3.

$$\begin{matrix}[ \begin{matrix}xw \\ zw\end{matrix} ] = \frac{H}{f} [ \begin{matrix}x 3 \\ y 3\end{matrix} ] & [ Equation 5 ] \\ [ \begin{matrix}x p \\ y p\end{matrix} ] [ \begin{matrix}\frac{fHx 3}{fh sin θ + Hy 3 cos θ} \\ \frac{f ( fh cos θ - Hy 3 sin θ )}{fh sin θ + Hy 3 cos θ}\end{matrix} ] & [ Equation 6 ] \\ [ \begin{matrix}x 3 \\ y 3\end{matrix} ] [ \begin{matrix}\frac{xp ( fh sin θ + Hy 3 cos θ )}{fH} \\ \frac{fh ( f cos θ - yp sin θ )}{H ( f sin θ + y p cos θ )}\end{matrix} ] & [ Equation 7 ]\end{matrix}$$

The coordinates (xp, yp) of the coordinate system Xp-Yp of the imaging surface S represent coordinates of the object scene image P_3 captured by the camera C_3. Therefore, the object scene image P_3 from the camera C_3 is transformed into the bird's-eye view image BEV_3 by using Equation 7. In reality, the object scene image P_3 firstly is subjected to an image process such as a lens distortion correction, and is then transformed into the bird's-eye view image BEV_3 by using Equation 7.

Subsequently, an operation for defining the cut-out area CT and an operation for reproducing the complete-surround birds-eye view image belonging to the defined cut-out area CT are described.

Firstly, the cut-out area CT is initialized so that it has a rectangle in which the overlapped areas OL_12 to OL_41 shown in FIG. 6 are four corners. Secondly, a value that is a times a speed of the vehicle 100 at this time point is set to a threshold value THmv, and a variable K is set to each of “1” to “6”.

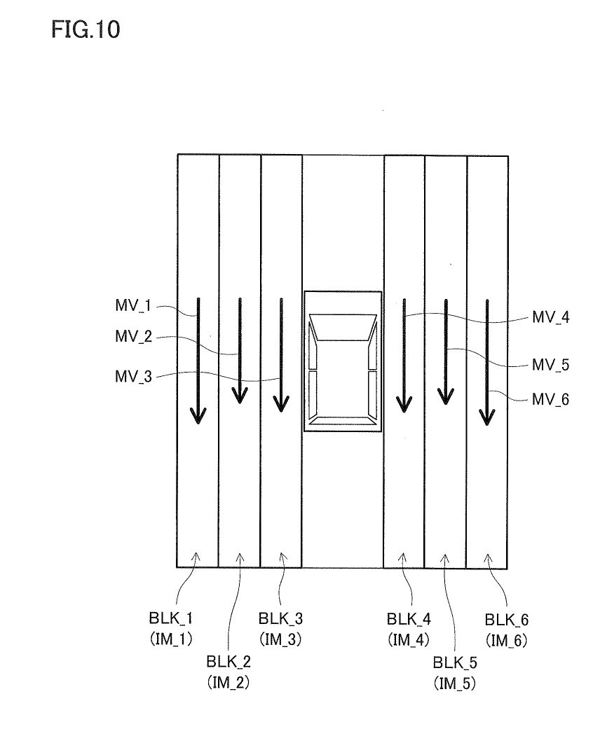

With reference to FIG. 10, on an area equivalent to the cut-out area CT in an initial state, strip-shaped blocks BLK_1 to BLK_6 are assigned. If the moving direction of the vehicle 100 is defined as a vertical direction and the direction orthogonal to the moving direction of the vehicle 100 is defined as a lateral direction, then the blocks BLK_1 to BLK_6 all have a vertically long shape. The blocks BLK_1 to BLK_3 are placed to be lined up in the lateral direction on a left side of the vehicle 100, whereas the blocks BLK_4 to BLK_6 are placed to be lined up in the lateral direction on a right side of the vehicle 100.

Motion vector amounts MV_1 to MV_6 are detected with reference to partial images IM 1 to IM_6 belonging to the blocks BLK_1 to BLK_6. Due to a birds-eye transformation characteristic, magnitudes of the detected motion vector amounts MV_1 to MV_6 differ depending on whether there is a three-dimensional object (architectural structure) in the blocks BLK_1 to BLK_6.

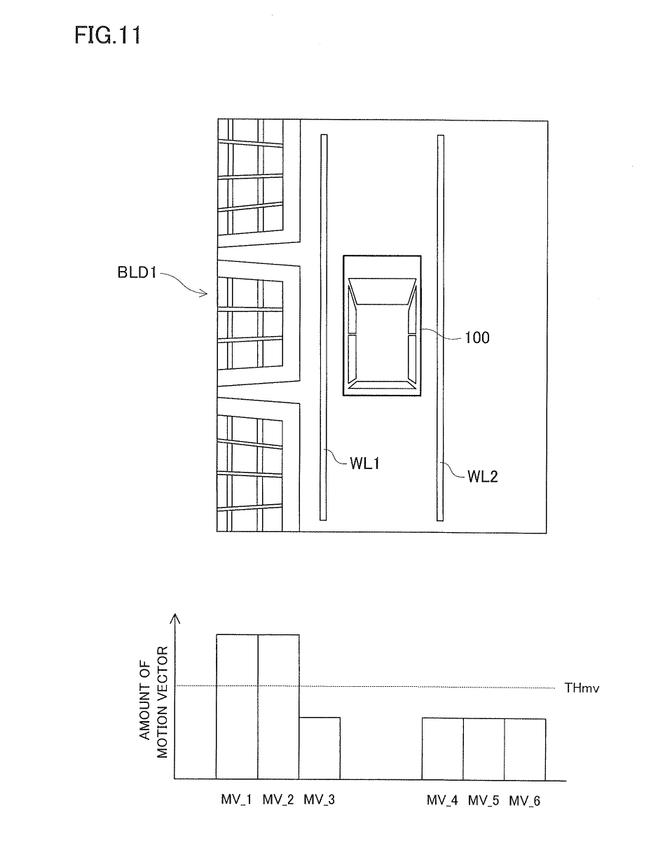

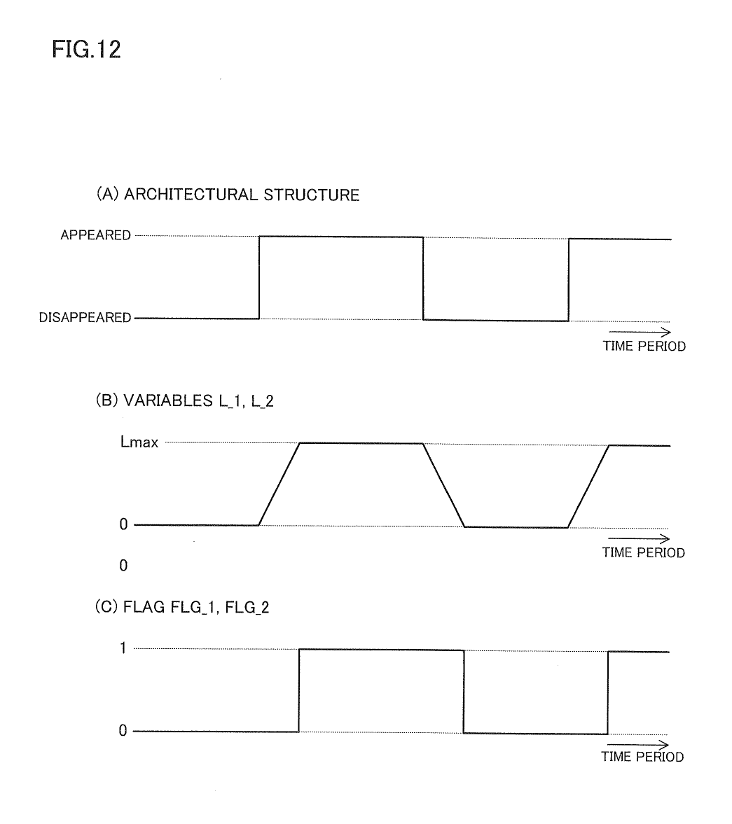

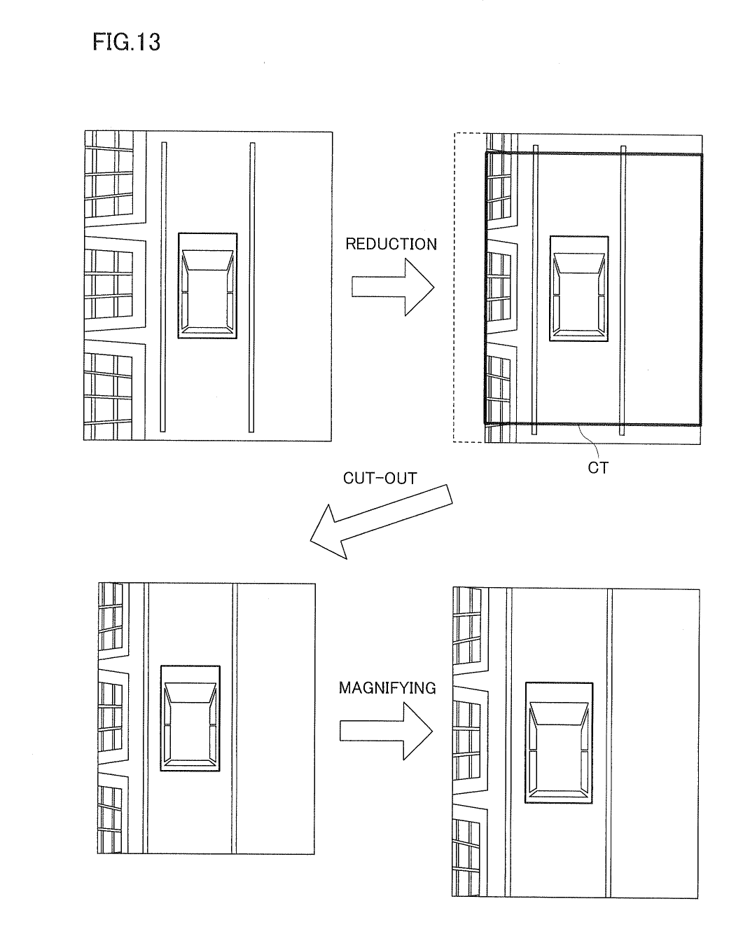

As shown in FIG. 11, if there is an architectural structure BLD1 on a left side of the vehicle 100 traveling along white lines WL1 and WL2 depicted on the road surface and an image representing the architectural structure BLD1 appears in the blocks BLK_1 to BLK_2, whereas an image representing the road surface appears in the blocks BLK3_ to BLK_6, then the motion vector amounts MV_1 to MV 2 exceed a threshold value THmv and the motion vector amounts MV 3 to MV_6 fall below the threshold value THmv.

The variable L_K is incremented up to a constant Lmax that is an upper limit when a motion vector amount MV_K (K: 1 to 6, the same applies below) exceeds the threshold value THmv, and is decremented down to “0” that is a lower limit when the motion vector amount MV_K is equal to or less than the threshold value THmv. A flag FLG_K is set to “1” when the variable L_K exceeds the constant Lmax, and set to “0” when the variable L_K falls below “0”.

Therefore, if a state shown in FIG. 11 is continued, the flags FLG_1 and FLG_2 are set to “1”, and the flags FLG_4 to FLG_6 are set to “0”. Moreover, when the architectural structure BLD1 is repeated appeared/disappeared as shown in FIG. 12(A), the variables L_1 and L_2 are updated as shown in FIG. 12(B), and the flags FLG_1 and FLG_2 are updated as shown in FIG. 12(C).

When the flag FLG_K is set to “1”, the partial image IM_K is reduced. More specifically, a lateral-direction size of the partial image IM_K is decreased to ½. The complete-surround bird's-eye view image is changed in shape as a result of the reduction of the partial image IM_K. The cut-out area CT is re-defined with reference to a horizontal size of the complete-surround bird's-eye view image thus changed in shape. The re-defined cut-out area CT has a horizontal size equivalent to the horizontal size of the complete-surround bird's-eye view image and an aspect ratio equivalent to an aspect ratio of a monitor screen, and a central position of the cut-out area CT matches a central position of the complete-surround bird's-eye view image.

Therefore, a complete-surround bird's-eye view image shown in an upper left of FIG. 13 is changed in shape as shown in an upper right of FIG. 13, and the cut-out area CT is re-defined as shown in the upper right of FIG. 13.

When the cut-out area CT is re-defined, a zoom factor of the complete-surround bird's-eye view image is calculated. The zoom factor is equivalent to a factor by which a difference between the size of the re-defined cut-out area CT and a size of the monitor screen is compensated. In a display command issued toward the display device 16, the re-defined cut-out area CT and the calculated zoom factor are written.

The display device 16 displays the complete-surround bird's-eye view image on the monitor screen according to such a display command. That is, the display device 16 cuts out the complete-surround bird's-eye view image belonging to the cut-out area CT, as shown in a lower left of FIG. 13, magnifies the cut-out complete-surround bird's-eye view image, as shown in a lower right of FIG. 13, and displays the magnified complete-surround bird's-eye view image on the monitor screen.

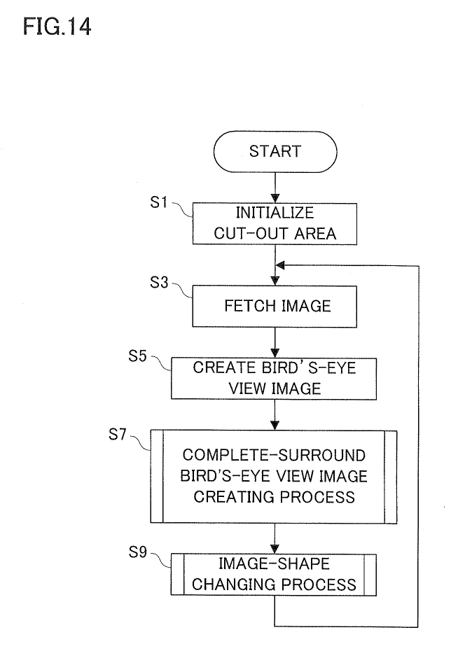

Specifically, the CPU 12p executes a process according to a flowchart shown in FIG. 14 to FIG. 17. It is noted that a control program corresponding to these flowcharts is stored in a flash memory 14 (see FIG. 1).

With reference to FIG. 14, in a step S1, the cut-out area CT is initialized, and in a step S3, the object scene images P_1 to P_4 are fetched from the cameras C_1 to C_4. In a step S5, based on the fetched object scene images P_1 to P_4, the bird's-eye view images BEV_1 to BEV_4 are created. The created bird's-eye view images BEV_1 to BEV_4 are secured in the work area W1. In a step S7, based on the bird's-eye view images BEV_1 to BEV_4 created in the step S3, the complete-surround bird's-eye view image is created. The created complete-surround bird's-eye view image is secured in the work area W2. In a step S9, the complete-surround bird's-eye view image secured in the work area W2 is subjected to the image-shape changing process. On the monitor screen of the display device 16, the drive assisting image based on the complete-surround bird's-eye view image changed in shape is displayed. Upon completion of the process in the step S9, the process returns to the step S1.

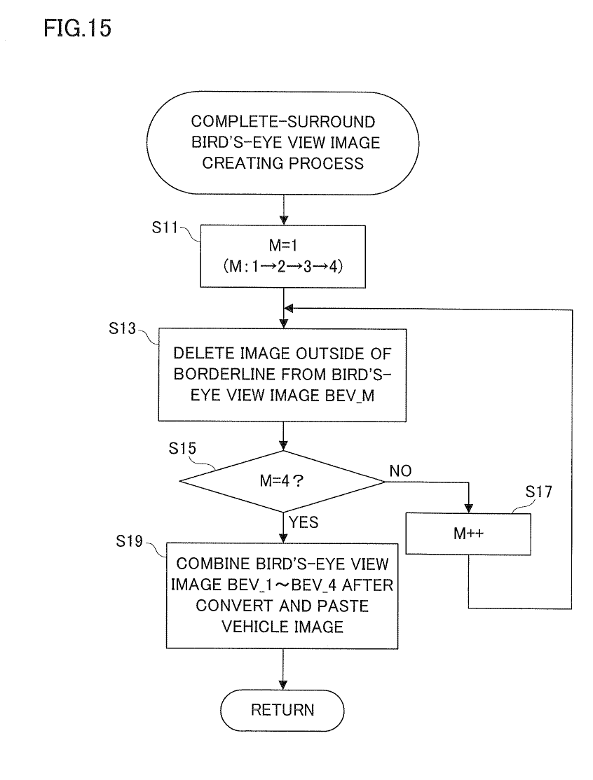

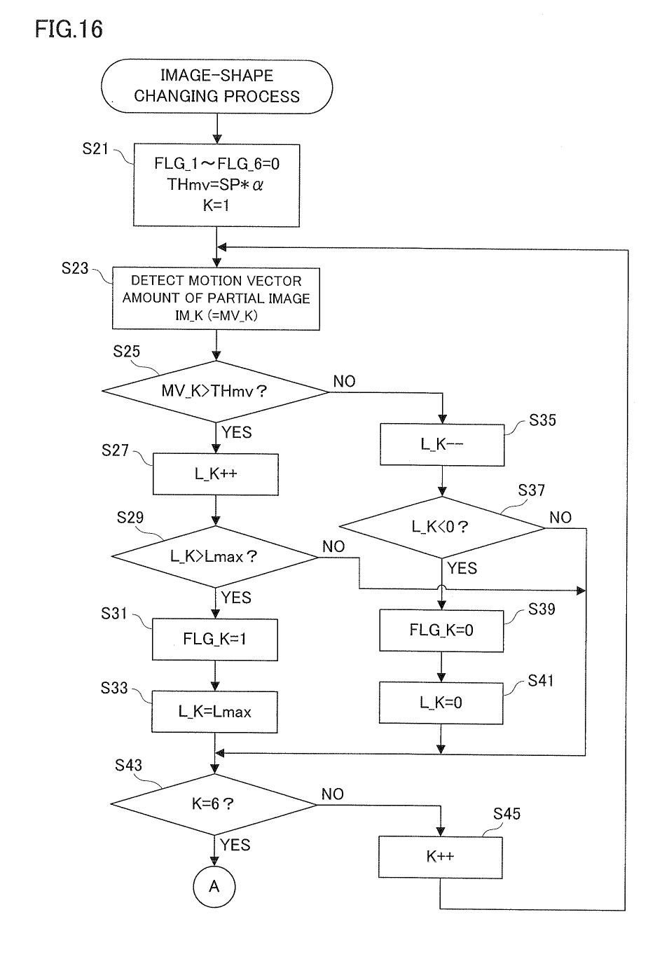

A complete-surround bird's-eye view image creating process in the step S7 follows a sub routine shown in FIG. 15. Firstly, in a step S11, the variable M is set to “1”. In a step S13, an image outside of the borderline is deleted from the bird's-eye view image BEV_M, and in a step S15, it is determined whether or not the variable M reaches “4”. When the variable M is less than “4”, the variable M is incremented in a step S17, and then, the process returns to the step S13. When the variable M reaches “4”, the process advances to a step S19. In the step S19, the parts of the bird's-eye view images BEV_1 to BEV_4 left after the deleting process in the step S13 are combined to one another by a coordinate transformation, and the vehicle image G1 is pasted to a center of the combined image. Upon completion of the complete-surround bird's-eye view image in this way, the process is restored to a routine at a hierarchical upper level.

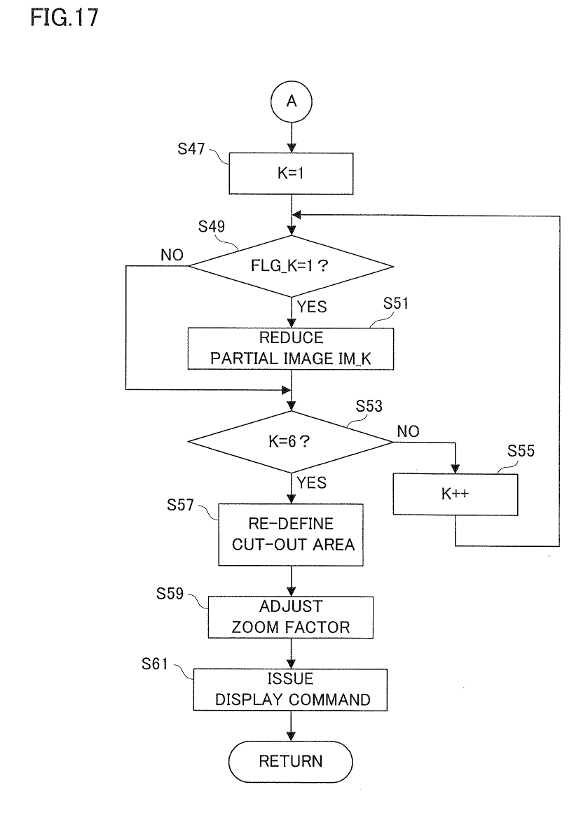

The image-shape changing process shown in the step S9 in FIG. 14 follows a sub routine shown in FIG. 16 and FIG. 17. In a step S21, the flags FLG_1 to FLG_6 are set to “0”, the threshold value THmv is set to a times the speed of the vehicle 100 at this time point, and then, the variable K is set to “1”.

In a step S23, the motion vector amount of the partial image IM_K is detected as MV_K, and in a step S25, it is determined whether or not the detected motion vector amount MV_K exceeds the threshold value THmv.

When a determination result is YES, the variable L_K is incremented in a step S27. In a step S29, it is determined whether or not the incremented variable L_K exceeds the constant Lmax. When the variable L_K is equal to or less than the constant Lmax, the process directly advances to a step S43. When the variable L_K exceeds the constant Lmax, the flag FLG_K is set to “1” in a step S31, and in a step S33, the variable L_K is set to the constant Lmax. Then, the process advances to the step S43.

When the determination result in the step S25 is NO, the variable L_K is decremented in a step S35, and it is determined in a step S37 whether or not the decremented variable L_K falls below “0”. When the variable L_K is equal to or more than “0”, the process directly advances to the step S43. When the variable L_K falls below “0”, the flag FLG_K is set to “0” in a step S39, and in a step S41, the variable L_K is set to “0”. Then, the process advances to the step S43.

In the step S43, it is determined whether or not the variable K reaches “6”. When a determination result is NO, the variable K is incremented in a step S45, and then, the process returns to the step S23. When the determination result is YES, the process advances to a step S47. The variable K is set to “1” in the step S47, and in a subsequent step S49, it is determined whether or not the flag FLG_K indicates “1”.

When the determination result is NO, the process directly advances to a step S53, and when the determination result is YES, the partial image IM_K is reduced in a step S51, and then, the process advances to a step S53. Specifically, the process in the step S51 is equivalent to a process for decreasing the size of the lateral direction of the partial image IM_K to ½. In the step S53, it is determined whether or not the variable K reaches “6”. When a determination result is NO, the variable K is incremented in a step S55, and then, the process returns to the step S49. When the determination result is YES, the process advances to a step S57.

In the step S57, a horizontal size of the complete-surround birds-eye view image changed in shape resulting from the process in the step S51 is detected, and the cut-out area CT is re-defined so as to be adapted to the detected horizontal size. In a step S59, with reference to the size of the re-defined cut-out area CT, the zoom factor of the complete-surround bird's-eye view image is calculated.

The re-defined cut-out area CT has the horizontal size equivalent to the horizontal size of the complete-surround bird's-eye view image and the aspect ratio equivalent to the aspect ratio of the monitor screen, and the central position of the re-defined cut-out area CT matches the central position of the complete-surround bird's-eye view image. The calculated zoom factor is equivalent to a factor by which a difference between the size of the re-defined cut-out area CT and the size of the monitor screen is compensated.

In a step S61, the display command in which the re-defined cut-out area CT and the calculated zoom factor are written is created, and the created display command is issued toward the display device 16. Upon completion of the process in the step S61, the process is restored to a routine at a hierarchical upper level.

As can be seen from the above description, the cameras C_1 to C_4 are arranged in the vehicle 100 that moves on the road surface, and capture the road surface from diagonally above. The CPU 12p repeatedly creates the complete-surround bird's-eye view image relative to the road surface, based on the object scene images P_1 to P_4 repeatedly outputted from the cameras C_1 to C_4 (S5, S7). The created complete-surround bird's-eye view image is reproduced on the monitor screen of the display device 16.

The CPU 12p determines whether or not there is the three-dimensional object such as an architectural structure in the side portion of the direction orthogonal to the moving direction of the vehicle 100, based on the complete-surround bird's-eye view image created as described above (S21 to S45). Thereafter, the CPU 12p adjusts the ratio of the partial image equivalent to the side portion noticed for the determining process, to the complete-surround bird's-eye view image reproduced on the monitor screen, based on the determination result (S47 to S59).

The ratio of the partial image equivalent to the side portion in the direction orthogonal to the moving direction of the vehicle 100 is adjusted to be differed depending on whether or not this partial image is equivalent to the three-dimensional object image. Thus, a reproducibility of the birds-eye view image is adaptively controlled, and as a result, the maneuver assisting performance is improved.

It is noted that in this embodiment, upon combining the bird's-eye view images BEV_1 to BEV_4, one portion of the image outside of the borderline BL is deleted (see FIG. 5). However, it may be also possible that two partial images representing a common viewing field are synthesized through weighted addition, and a weighted amount referred to during the weighted addition is adjusted based on a difference in magnitude of the three-dimensional object image.

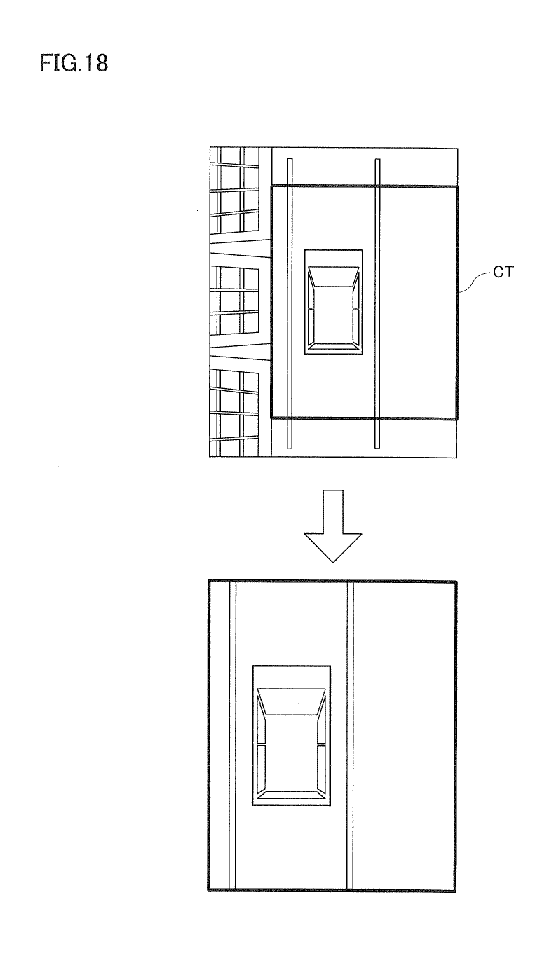

Furthermore, in this embodiment, the size of the lateral direction of the three-dimensional object image is compressed to ½. However, the three-dimensional object image may be optionally non-displayed, as shown in FIG. 18.

Notes relating to the above-described embodiment will be shown below. It is possible to arbitrarily combine these notes with the above-described embodiment unless any contradiction occurs.

The coordinate transformation for producing a bird's-eye view image from a photographed image, which is described in the embodiment, is generally called a perspective projection transformation. Instead of using this perspective projection transformation, the bird's-eye view image may also be optionally produced from the photographed image through a well-known planer projection transformation. When the planer projection transformation is used, a homography matrix (coordinate transformation matrix) for transforming a coordinate value of each pixel on the photographed image into a coordinate value of each pixel on the bird's-eye view image is evaluated in advance at a stage of a camera calibrating process. A method of evaluating the homography matrix is well known. Then, during image transformation, the photographed image may be transformed into the bird's-eye view image based on the homography matrix. In either way, the photographed image is transformed into the bird's-eye view image by projecting the photographed image on the bird's-eye view image.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A maneuver assisting apparatus, comprising:
a plurality of cameras which are arranged on a moving object that moves on a reference surface and which capture the reference surface from diagonally above;
a creator which repeatedly creates a bird's-eye view image relative to the reference surface based on an object scene image repeatedly outputted from each of the plurality of cameras;
a reproducer which reproduces the bird's-eye view image created by said creator;
a determiner which determines whether or not there is a three-dimensional object in a side portion of a direction orthogonal to a moving direction of the moving object based on the bird's-eye view image created by said creator; and
an adjuster which adjusts a ratio of a partial image equivalent to the side portion noticed by said determiner to the bird's-eye view image reproduced by said reproducer based on a determination result of said determiner.

2. A maneuver assisting apparatus according to claim 1, wherein said determiner includes: a detector which repeatedly detects a motion vector amount of the partial image equivalent to the side portion out of the birds-eye view image; an updater which updates a variable in a manner different depending on a magnitude relationship between the motion vector amount detected by said detector and a threshold value; and a finalizer which finalizes the determination result at a time point which a variable updated by said updater satisfies a predetermined condition.

3. A maneuver assisting apparatus according to claim 2, wherein said determiner further includes a threshold value adjustor which adjusts a magnitude of the threshold value with reference to a moving speed of the moving object.

4. A maneuver assisting apparatus according to claim 1, wherein said adjuster includes a changer which changes a size of the partial image and a controller which starts said changer when the determination result is positive and stops said changer when the determination result is negative.

5. A maneuver assisting apparatus according to claim 4, wherein said changer decreases a size in a direction orthogonal to the moving direction of the moving object.

6. A maneuver assisting apparatus according to claim 4, wherein said reproducer displays a bird's-eye view image belonging to a designated area out of the bird's-eye view image created by said creator on a screen, and said adjustor further includes a definer which defines the designated area in a manner to have a size corresponding to a size of the partial image and an adjustor which adjusts a factor of the bird's-eye view image belonging to the designated area so that a difference in size between the designated area and the screen is compensated.
